(19) United States
(12) Patent Application Publication
(10) Pub. No.: US 2013/0248552 A1
(43) Pub. Date: Sep. 26, 2013

(54) PATTY PAPER AND DISPENSING MECHANISM THEREOF

(71) Applicant: Erik M. BAUER, Alto, MI (US)

(72) Inventor: Erik M. BAUER, Alto, MI (US)

(73) Assignee: HOLLYMATIC CORPORATION, Countryside, IL (US)

(21) Appl. No.: 13/897,185

(22) Filed: May 17, 2013

Related U.S. Application Data
(63) Continuation of application No. 13/408,573, filed on Feb. 29, 2012.

(51) Int. Cl. B65D 83/08; B32B 29/06

(52) U.S. Cl. CPC B65D 83/08; B32B 29/06
USPC 221/26; 428/137

(57) ABSTRACT

Provided herein are a sheet of wax-coated paper for separating food patties and a paper dispensing apparatus for dispensing sheets of the paper, the apparatus including: a frame configured to dispense a sheet of paper; a hopper connected to the frame and configured to hold a stack of the sheets of paper within the hopper, the hopper having an opening from which the sheets are dispensed; a pair of guides within the hopper, the guides being disposed on inner surfaces of the hopper, formed to correspond to notches in the sheets of paper, and configured to hold the sheets of paper within the hopper; and a rod which is mounted in the frame and extends upward through the hopper, and configured to fit through holes in the sheets of paper.

### CROSS REFERENCE TO RELATED APPLICATIONS

This application claims benefit from U.S. application Ser. No. 13/408,573, filed Feb. 29, 2012, the entire disclosure of which is incorporated by reference herein.

### BACKGROUND

Apparatuses and methods consistent with exemplary embodiments relate to a food portioning machine, and more particularly to a patty sheet and a patty sheet dispensing mechanism for a patty forming machine.

In the related art, various types of portioning machines are used to produce portions in the form of patties. In some portioning machines, sheet-formed paper is used for separating the portions. The sheets are typically dispensed from a paper-fed portioning system, which feeds the bottom-most sheet of paper from a vertical stack of individual sheets.

One type of portion control machine forms patties of flowable material, such as ground meat. Historically, patties were formed by hand. However, as hand forming patties involves human contact, it also can involve a higher risk of unsanitary conditions. Another problem is that hand forming patties typically results in a lack of uniformity in weight, size and shape of the patties. However, hand-based patty forming methods also suffer from inherent limitations on worker output. Specialized patty forming machines can overcame many of these shortcomings by producing patties in a sanitary manner, with substantial uniformity in size, shape and weight, and patties can be produced at a much faster rate than via the hand forming method. Specialized patty forming machines can provide significant increases in quality and efficiency.

The related art patty forming machines typically include a mechanism to dispense sheets of paper to be contacted with the patty to ensure separation of each patty from other patties or surfaces. The sheets prevent “sticking” between patties or portions thereof. The most commonly used type of sheet is made of paper coated with wax. Some dispensing mechanisms use rolls of paper that are cut or torn to a desired length. However, the paper rolls must be continuously replaced, which inevitably results in down time for the patty-making machine and interruption of the patty-making process.

Other paper dispensing mechanisms utilize precut sheets of paper that have one or more holes in the paper. A stack of paper is then placed into a hopper having a rod which protrudes upward through all of the holes in the stack of paper. The holes work to ensure that the paper has resistance to the force trying to pull it out. By creating this resistance, only one sheet of paper is pulled out and inserted between the patties. Without such resistance, or “hold back” force there is a higher chance of “double-sheeting,” i.e., dispensing more than one sheet at a time. Double-sheeting not only wastes paper, but patty stacks tend to fall when double sheeting occurs, resulting in product loss, inefficiencies, and an overworking of the product (e.g., having to run meat through the machine multiple times). In these types of portioning systems, sheets are stacked with the holes aligned and fitting over rods or pins from which the paper is torn during dispensing.

However, the hole/rod-type system is not without drawbacks. One problem is that the rods must be threaded through the holes, which increases the difficulty in loading the paper. Sometimes paper is torn or cut off during dispensing. Such cutting or tearing of the paper can result in small fragments of paper being deposited upon the patty. Another issue is that the paper may not be securely held in a horizontal position in the stack, for example if only a single rod and hole is used. As a result the paper might shift to one side or another and ultimately get stuck during the dispensing process. Further still, when the paper is torn from the rod during a dispensing operation, the paper tends to split more near the hole, resulting in a gap in the paper that may expose a surface of the patty to other, possibly contaminated, surfaces. While the length of the paper can be increased to compensate for this gap, lengthening the paper of course results in increased costs due to higher paper consumption.

Such problems have led to the development of another type of paper dispensing mechanism where the sheets are provided with deformable elements, such as notches in the side edges of the sheets. For example, U.S. Pat. No. 5,137,172 (“the '172 patent” hereinafter), which is hereby incorporated by reference in its entirety, shows a paper feeding system suitable for use with a patty making machine to provide paper for separating the patties.

As shown in the '172 patent, a vertical stack of sheet-formed paper may be provided with notches on the side edges. A paper hopper is adapted to receive and temporarily retain the stack of paper sheets and is adapted to dispense the sheets by feeding the bottom-most sheet of paper from the stack. A pair of male guides located along the inside surface of the paper hopper serve to engage the notches on the side edges of the sheets. A proximal end of the male guide adjacent to where the paper is dispensed temporarily retains the paper sheets in such a manner that the bottom-most sheet is dispensed without tearing the paper. The guide also helps prevent some unwanted movement of a sheet of paper within the paper hopper in both the X direction and the Y direction, with respect to a plane of the sheet of paper.

Normally, the frictional force between the bottom-most sheet that is being dispensed and the next sheet in the stack is insufficient to pull the next sheet free from the guide, as it is not able to overcome the hold back force resulting from the extreme bend required to free the paper from the guide. Accordingly, the next sheet is maintained within the paper hopper by its notch and thus the paper should be dispensed only a single sheet at a time. The notches on the side edges of the sheets thus cause each individual sheet to bend at an extreme angle when pulled past the male guide without tearing the paper. The notches therefore work to reduce the side to side movement of the paper, which ultimately reduces misfeeds. Misfeeds may occur as the paper is being dispensed, and may include twisted paper, folded paper, or paper that does not keep the patties from touching one another. As a consequence, misfeeds can dramatically affect production efficiency. Misfeeds may also result in an overworking of the product, for example, if the meat has to be ran through the machine multiple times. The notched paper dispensing system addresses these issues.

However, the notched paper sheets must be sufficiently stiff to provide the force necessary to hold back the upper sheets, and thereby allow only a bottom-most sheet to be pulled away. Nonetheless, problems still have been encountered with certain sheet-formed paper stock wherein there still is a tendency to pull two sheets of paper at a time if the paper feed system is not adjusted properly. Adding a more severe bend to the deformed or notched paper to increase its hold back force might be considered a solution to this problem, but it has been found that there is a tendency to tear the paper if it must be deformed too severely.

Another problem with previous stock paper feed systems is that thinner sheets have a tendency to bow downwardly and fall out of the support means of the system. The feed mechanisms used to depose the separating sheets between the patties or portions require that the sheet be supported under two of its opposite edges. Specifically, the sheets are fed along a support means which normally includes a pair of side guides which support the two opposite side edge areas of the sheets. While supported, a patty or portion is deposited on top of a sheet which is then accelerated downward to the top of a stack below. Repeated positioning of additional sheets and subsequent depositing of the portions forms a stack of interleaved patties

Previously, thinner sheets, e.g., on the order of 0.002 inches thick, could not be used because they had a tendency to fall down between the side support guides due to their own weight, even before a portion is deposited on the sheet. Therefore, “stiffer” interleaf sheets which would remain in position and did not fall out of the support guides during stacking were used.

An alternative solution was to provide a means for stiffening the sheets so that they do not fall through the support means, particularly providing a sheet without adding significant cost. In addition, the stiffening means can be used to reinforce deformable elements or notches at the side edges of the sheets to increase the hold back forces necessary to allow a bottom-most sheet to be pulled away from the next sheet in a stack thereof.

However, these notches only provided improved support at the front and back portions of the sheet and did not provide improved support at the sides. As the paper was pulled forward, the paper would sag at the center and pull away from the sides, limiting the through put of the patty portion control machine and requiring the use of thicker, less flexible sheets.

Still another problem with the use of the side guides and the notches is that as the quantity of paper in the stack reduces, the remaining paper tends to bow more, as the weight pressing on the page being dispensed above reduces. As a result, the force from above may be insufficient to keep the paper feeding out of the dispenser at an optimal rate. The weight of the paper (or the weight on top of the paper) helps feed the paper accurately and reduces double feeding of sheets and misfeeds. To solve this problem, a heavy weight may be placed on top the paper being fed into the machine in order to create the additional hold back force necessary to minimize misfeeds. However, even with the added weight, another problem occurs in that the paper hopper has to be refilled before it is empty or more misfeeds will result, as the overall weight of the stack decreases. This type of system therefore requires that the operator frequently monitor and maintain an adequate supply of paper in the hopper.

In view of these shortcomings, there remains a need for an improved sheet-formed paper and dispensing system without the inherent problems discussed above.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

According to an aspect of an exemplary embodiment, there is provided a paper dispensing apparatus for dispensing sheets of paper for a patty forming machine, wherein each sheet of paper has notches and a hole, the paper dispensing apparatus including: a frame which connects the paper dispensing apparatus to the patty forming machine and is configured to dispense a sheet of paper from among the sheets of paper; a hopper which is connected to the frame and configured to hold the sheets of paper in a stack within an inner space of the hopper, and the hopper includes a bottom opening from which the sheets of paper are dispensed; a pair of guides within the hopper, wherein each guide of the pair of guides is disposed on an inner surface of a sidewall of the hopper, and the pair of guides are formed to correspond to a shape of the notches in the sheets of paper and the pair of guides are configured to hold the sheets of paper within the hopper; and a rod which is mounted in the frame and extends upward through the inner space of the hopper, wherein the rod is configured to fit through the holes of the sheets of paper.

A sheet of paper may be dispensed from the bottom opening in the hopper by application of a force which tears the sheet being dispensed such that the hole in the sheet being dispensed is torn from around the rod.

The frame and the hopper may be integrally formed.

Each of the guides may include a protruding portion which protrudes toward a respective notch in each of the sheets of paper within the hopper.

The protruding portion of each of the guides may include a tip which is closest to the respective notch in each of the sheets of paper, and a base portion which is connected to a respective sidewall of the hopper.

The tip and the base portion may be integrally formed.

According to an aspect of an exemplary embodiment, there is provided a sheet of wax-coated paper for separating patties of food produced by a food portioning machine having a paper feeding apparatus for dispensing a bottom-most sheet of paper from a vertical stack of a plurality of sheets of the wax-coated paper, each sheet of the wax-coated sheet of paper including: a pair of notches formed respectively at left and right edges of the sheet of wax-coated paper, wherein each of the notches are configured to receive a male guide within the paper feeding system; and a hole formed in the sheet of wax-coated paper, wherein the hole is configured to accommodate a retaining rod within the paper feeding apparatus, wherein the hole is formed at a location near a rear edge of the sheet of wax-coated paper, and the hole is formed of a predetermined size so that the hole of the bottom-most sheet of wax-coated paper rips as the bottom-most sheet of wax-coated paper is torn from around the retaining rod during the dispensing of the bottom-most sheet of wax-coated paper.

The sheet of wax-coated paper may be square in shape.

The notches may be semi-circular in shape.

The hole may be circular in shape.

### BRIEF DESCRIPTION OF THE DRAWINGS

The above and/or other aspects will be more apparent by describing in detail exemplary embodiments, with reference to the accompanying drawings, in which:

FIG. 1 illustrates a perspective view of a paper feed system according to an exemplary embodiment;

FIG. 2 illustrates another perspective view of a paper feed system according to an exemplary embodiment;

FIG. 3 illustrates an example of a piece of paper according to an exemplary embodiment;

FIG. 4 shows another perspective view of a paper feed system according to an exemplary embodiment;

FIGS. 5A-5C show a piece of wax paper according to different exemplary embodiments;

FIG. 6A shows a perspective view of a notch formed in a sheet of paper according to an exemplary embodiment;

FIG. 6B shows a perspective view of a hole formed in a sheet of paper according to an exemplary embodiment;

FIG. 7A shows a perspective view of a hopper guide according to an exemplary embodiment; and

FIG. 7B shows a perspective view of a rod according to an exemplary embodiment.

### DETAILED DESCRIPTION OF THE EXEMPLARY EMBODIMENTS

First, the terms used in the present disclosure will be briefly described below before exemplary embodiments of the present inventive concept are described in greater detail.

Most of the terms used herein are general terms that have been widely used in the technical art to which the present inventive concept pertains. However, some of the terms used herein may be created reflecting intentions of technicians in this art, precedents, or new technologies. Also, some of the terms used herein may be arbitrarily chosen. In this case, these terms are defined in detail below. Accordingly, the specific terms used herein should be understood based on the unique meanings thereof and the whole context of the disclosure as set forth herein.

In the present specification, it should be understood that the terms, such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Also, the terms, such as “portion” “piece,” “section,” “part,” etc., should be understood as a part of a whole; an amount, section or piece. Further, as used herein, the term “and/or” includes any and all combinations of one or more of the associated listed items. Expressions such as “at least one of,” when preceding a list of elements, modify the entire list of elements and do not modify the individual elements of the list.

The term “sheet” or “paper,” is used interchangeably herein and refers to a piece of paper on which food patties (e.g., meat patties) are formed and dispensed from a portioning machine. The terms “portioning machine” and “portioning system” are used interchangeably herein. The terms “paper feed system,” “paper-fed system,” “paper feeding system” and “paper feeding mechanism” are used interchangeably herein. As used herein, the term “processor” refers to a person or other entity which employs a portioning system, such as a meat portioning machine, or more specifically, a patty-making machine. Furthermore, the term “processor,” as used herein, may also include a manufacturer, distributer, reseller, or other downstream entity which uses, stores, sells, etc., a portioning system. As used herein, the term “operator” refers to a person or other entity (e.g., a robot) which controls an operation of a portioning system.

Hereinafter, exemplary embodiments of the present invention will now be described more fully with reference to the accompanying drawings. The present inventive concept may, however, be embodied in many different forms and should not be construed as being limited to the exemplary embodiments set forth herein. Rather, these exemplary embodiments are provided so that this disclosure will be thorough and complete and will fully convey the concept of the invention to those of ordinary skill in the art. In the following description, well-known functions or constructions are not described in detail if it is determined that as they would obscure the disclosure due to explanation of the exemplary embodiments in unnecessary detail. The same reference numerals represent the same elements throughout the drawings.

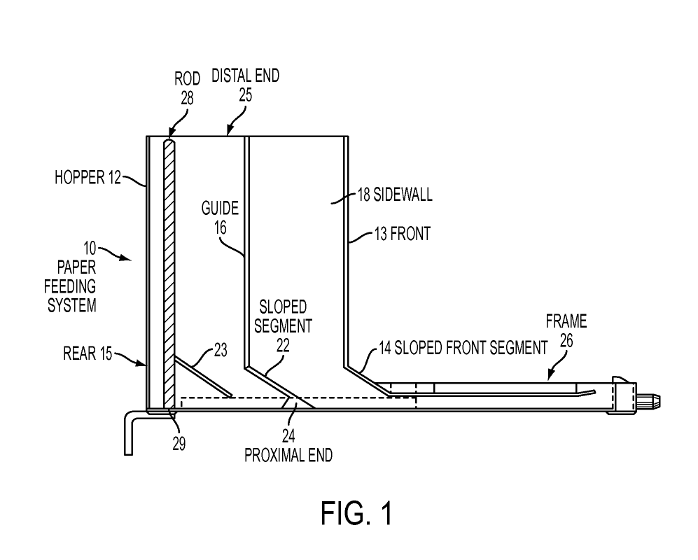

FIG. 1 shows an exemplary embodiment of the present invention. As shown in FIG. 1, a paper feed system 10 is provided, including a frame 26, a paper hopper 12, which holds the cut sheets of paper in a stack, and a rod 28. The hopper 12 can be attached to a frame 26, or the hopper 12 and the frame can be integrally formed. The hopper 12 has a front 13 from which the paper is dispensed, and rear 15 which is opposite the front 13. The front 13 can be a wall or can be open and defined by the front edge of the paper. The guide 16 has a proximal end 24 that includes the sloped segment 22 which is adjacent to an opening at the bottom of the frame 26 where the paper is dispensed. Another sloped section 23 is near the rod 28. The sloped sections 22 and 23 help guide the paper during the dispensing process from its original position in the stack in the hopper down toward the opening at the bottom of the frame 26 where the paper is dispensed.

A guide 16 is provided on the interior surface of each of the sidewalls 18 of the hopper 18. Each guide 16 extends from an area above the sloped segment 22 up to the distal end 25 of the paper hopper 12. In an exemplary embodiment, the guides 16 are male elements extending from the surfaces as illustrated and described above. Alternatively, one or both of the guides may be a female element extending into the sidewall. Further, it should be noted that the other exemplary embodiments may have a guide associated with only one sidewall, or more than one guide associated with each sidewall. The guides 16 can be attached to the inner sidewalls of the hopper 12 or the guides 16 can be integrally formed on the inner sidewalls of the hopper 12.

The rod 28 may be disposed at a fixing location 29 which is near the rear portion 15 of the hopper 12. In particular, the rod 28 may be screwed into the bottom portion of the frame 26 at the fixing location 29 or connected to the bottom portion of the frame 26 in another manner, such as via a weld at the location 29. Further the rod 28 may pass through the bottom portion of the frame 26 at the fixing location 29 and then a nut or retainer (not shown) may be used on the other side of the bottom surface of the hopper in order to secure the rod 28 in an upright position extending upward though the space defined by the inner part of the hopper 12.

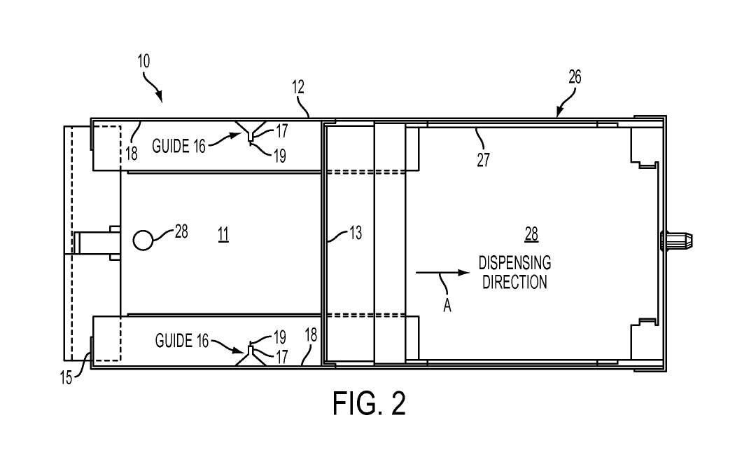

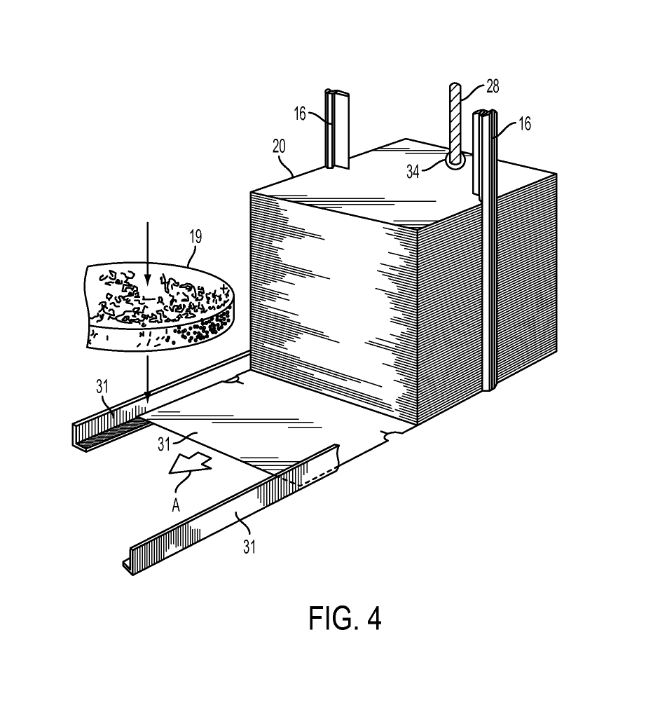

FIG. 2 shows top-down perspective view of the paper feeding system according to an exemplary embodiment. As shown in FIG. 2, the frame 26 is connected to the hopper 12. The hopper 12 may formed as a separate element which is attached to the frame 26, or the hopper 12 and the frame 26 may be integrally formed. The hopper 12 includes the rod 28, which is disposed near the rear portion 15 of the hopper 12, and the guides 16 on the sidewalls 18. The front portion 13 of the hopper 12 faces the dispensing direction A which is shown in FIGS. 2 and 4.

The guides 16 shown in FIG. 2 include a protruding portion 17, and a tip 19 extending toward the inner space 11 defined by the walls of the hopper 12. It should be noted that the shape of the guides 16 is not limited to the shape shown in FIG. 2. For example, the guides 16 may be substantially triangular, semi-circular, square, rectangular, trapezoidal, etc. Furthermore, the guides 16 may include a protruding portion 17 and a tip 19, or may include only a protruding portion 17 or only a tip 19, or alternatively, the guides 16 may not include any protruding portion 17 or tip 19. Moreover, the shape of the protruding portion 17 and tip 19 may differ from the respective shapes illustrated in FIG. 2. For example, the protruding portion 17 and/or tip 19 may be substantially triangular, semi-circular, square, rectangular, trapezoidal, etc., in shape. The tip 19 and the protruding portion 17 may be integrally formed or connected to each other (e.g., via a weld, or some other means of connection).

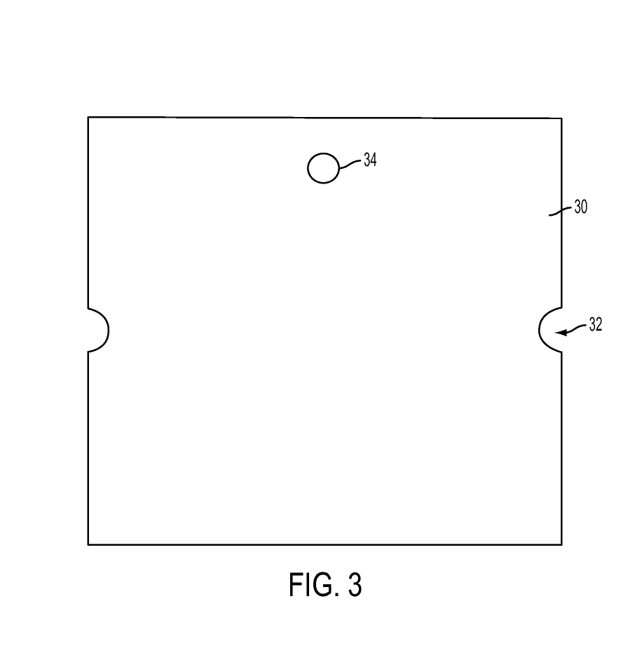

FIG. 3 shows an example of the paper according to an exemplary embodiment. As shown in FIG. 3, the paper 30 may be square in overall shape, and include notches 32 and a hole 34. The notches 32 are shaped to accommodate the shape of the guides 16. The hole 34 is shaped to accommodate the rod 28. When a the paper is stacked, the holes 34 in each sheet of paper are aligned so that the rod 28 may fit through all of the sheets from the bottom of the stack to the top of the stack, and the notches 32 are aligned so that the guides 16 fit into to respective notches 32. The paper may then be loaded into the hopper 12 with the notches on the sides (i.e., facing the sidewalls 18) in order to accommodate the guides 16, and with the holes 32 in the rear portion 15 of the hopper 12 in order to accommodate the rod 28.

It should be noted that although FIG. 3 shows a particular exemplary embodiment of the paper 30, the present invention is not limited thereto. For example, the paper 30 may be formed in shapes other than a square, such as a rectangle or even a circle or an oval. Further, the notches 32 may be formed in shapes other than a semi-circle, such as square, rectangular, trapezoidal, etc. Similarly, the hole 34 may be formed in a shape other than a circle, such as a square, diamond, polygon, etc. However, Both the notches 32 and the hole 34 are shaped to accommodate the guides 16 and the rod 28, respectively.

FIG. 4 shows another perspective view of the paper feeding system according to an exemplary embodiment. As shown in FIG. 4, the stack of paper 20 is held in place by the guides 16 and retained by the rod 28. The guides 16 fit into the notches 32 in each sheet of paper 30 in the stack 20. During the dispensing operation, the bottom-most sheet of paper 31 is torn from around the rod 28 and dispensed in the direction A along the side rails 31 of the frame 26. The patty 19 is formed and dropped onto a top surface of the bottom-most sheet of paper 31, once the bottom-most sheet of paper 31 has been dispensed.

In more detail, referring again to FIG. 4, a dispensing force is applied to the bottom-most sheet of paper 31 causing the hole 34 of bottom-most sheet of paper 31 to rip from around the rod 28. The bottom-most sheet of paper 31 is then moved forward along the side rails 31 of the frame 26 in the direction A where it receives the formed patty 19 being dropped. Once the patty 19 lands onto the dispensed sheet of paper (i.e., the bottom-most sheet of paper 31), the patty 19 and sheet keep moving in direction A so the that patty 19 and sheet may be moved away from the paper feeding system 10 (e.g., along a conveyer belt (not shown)).

Additionally, the hole 34 may be located at a location on the sheet of paper 30 where the hole may be ripped from around the rod 28 by a predetermined amount of force applied to the bottom-most sheet of paper 31. The size and shape of the hole 34 may also be altered so as to facilitate a continuous dispensing operation. That is, the size, shape and location of the hole 34 may vary depending on the amount of force desired to perform the dispensing of the bottom-most sheet of paper 31 from the paper feeding system 10.

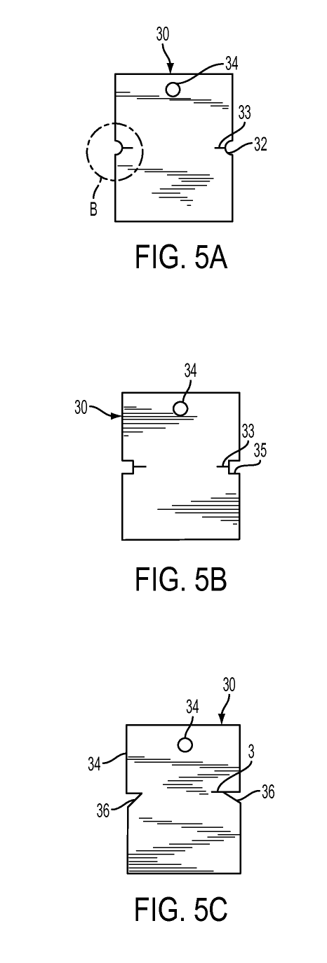

FIGS. 5A, 5B and 5C show examples of sheets of paper according to exemplary embodiments. As shown in FIG. 5A, and as described above with respect to FIG. 3, an individual sheet 30 may be formed to include semi-circular notches 32. However, each of the notches 32 may also include a slit 33 to accommodate the tip 19 of the guide 16. FIG. 5B shows a square-shaped notch 35 having a slit 33, and FIG. 5C shows a triangular-shaped notch 36 with slit 33. Each sheet of paper, as shown in FIGS. 5A-5C includes a hole 34.

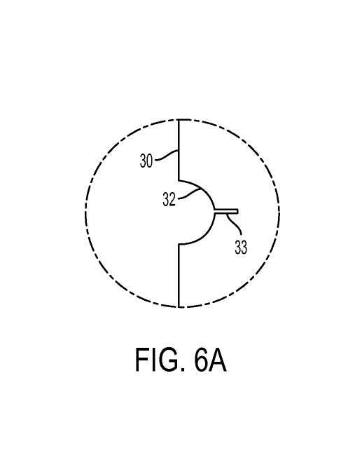

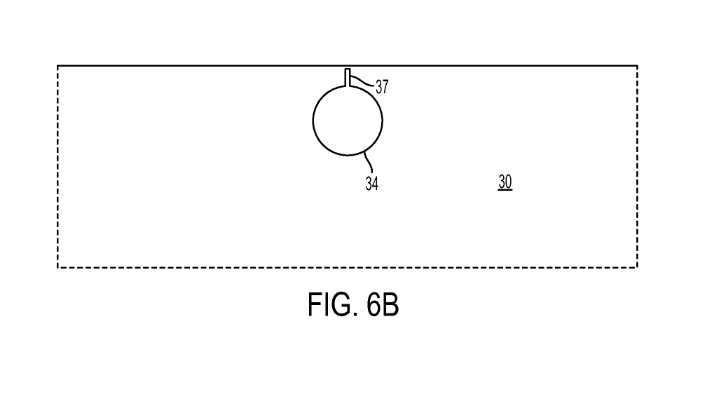

FIG. 6A shows a close up perspective view of an area B illustrated in FIG. 5A. As shown in FIG. 6A, the notch 32 in the paper 30 may be semi-circular in shape and include a slit 33 to accommodate the corresponding shape of the guide 16, protruding portion 17 and tip 19. However, as noted above, the present invention is not necessarily limited to the exact size, shape and location of the notches 32 shown in FIGS. 3, 5A-5C, or the notch 32 shown in FIG. 6A. The slit 33, when used with the guide 16 having the tip 19, serves to provide extra side support of the sheet, increasing the throughput of the patty forming machine while simultaneously allowing for thinner paper.

FIG. 6B shows a close-up perspective view of a hole 34 in a sheet of paper 30 according to another exemplary embodiment. As shown in FIG. 6B, the hole 34 may also include a slit 37. Here, the slit 37 serves to allow the sheet to be torn from the rod in a more consistent and cleaner fashion. In FIG. 6B, the slit 37 is shown as a small rectangular section, however the present invention is not limited thereto. The slit 37 may have a different shape, such as substantially triangular, semi-circular, square, rectangular, trapezoidal, etc. Moreover, the slit 37 may be formed to extend a short distance from the hole 37, or it may be formed to extend all the way to the edge of the paper 30.

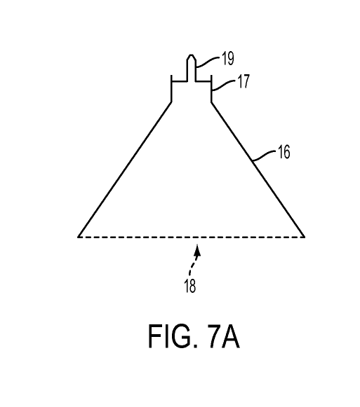

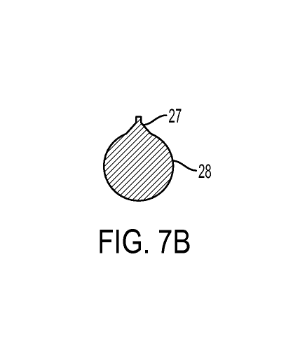

FIG. 7A shows a close up perspective view of a guide 16. As shown in FIG. 7A, and as noted above, the guide 16 may include a protruding portion 17 and a tip 19. Also, the guide 16 may be formed separately from the side wall 18 of the hopper 12, and then attached to the side wall 18, or alternatively, the guide may be integrally formed with the side wall 18. Further, as noted above with respect to the notches 32, the present invention is not necessarily limited to the exact size, shape and location of the guide 16 shown in FIG. 7A.

FIG. 7B shows the a top perspective view of the rod 28, which has a protrusion 27 formed to fit the slit 37 shown in FIG. 6B. As with the slit 37, the shape of the protrusion 27 may differ from the shape shown in FIG. 7B. For example, the protrusion 27 may have a different shape, such as substantially triangular, semi-circular, square, rectangular, trapezoidal, etc. Of course, the slit 37 may be shaped accordingly to accommodate the shape of the protrusion 27.

One benefit of using the holes and rods together with the notches (or even a side notch), is that the amount of weight required on top of the stack of paper to ensure proper feeding of the paper is reduced. Due to the extra stability and improved hold back force provided by the guides and the hole and rod coupling, the need for extra weight on the top of the paper stack is diminished. As a result, operators do not have to refill the stack of paper in the hopper as often as they would if they were only using the side notched paper in a corresponding paper feeding machine, since the weight of the extra paper on top of the stack is no longer required to force the bottom-most sheet to feed cleanly. Not having to constantly “top off” the stack means less time spent reloading the paper.

Another good result is that the number of paper misfeeds may be reduced. It is possible to find an optimal fit between the side notches and guides, as well as with the holes and rod, whereby the above-mentioned extra stability and improved hold back force is maximized. The synergistic effect resulting from the location, size and shape of the hole(s) and rod(s), as well as the guide(s) allows the sheets of paper to be dispensed one at a time from the bottom of the hopper with a reduced rate of paper misfeeds.

The increased stability and hold back force attributed to the interaction of the guides/holes/rod of the exemplary embodiment also allows for more precise control of the paper during the paper feeding process. For example, as the bottom-most sheet is torn from around the rod, the tear is contained to a desired area, and does not tend to result in torn pieces or overly large torn spots. As a result, the chance of contamination due to a patty contacting another surface is significantly reduced, since the dispensed paper under the present invention paper may be typically free of these sorts of potentially patty-exposing defects.

Additionally, reduced cost and increased production efficiency may be realized by using the paper and paper feeding system of the present invention. Current paper-fed food portioning systems may utilize both types of machines separately (i.e., one machine with side-notched paper and another machine with un-notched paper having a hole or holes stacked on a rod or rods). Using multiple machines not only requires additional costs associated with the machines themselves, such as initial cost of the machine, maintenance, employee training, complexity of operation, etc., but also additional costs, which are incurred by the making and/or buying, and storing all of the different types of paper required. The problem is compounded if different sizes of paper are used with different types of machines, since even more types of paper must be made/bought and stored. The single machine under one of the exemplary embodiments described herein avoids these problems since it minimizes the number of types of paper utilized.

If a processor makes his paper stock, more specialized components, such as paper cutting equipment, become necessary. Multiple machines and paper sizes necessarily require an array of different cutting tools, which are not necessarily interchangeable. However, if a single type of paper stock is used, such as described in the exemplary embodiments provided herein, the paper-associated costs may be decreased since fewer pieces of specialized paper-making equipment would be needed. Moreover, changing paper cutting parts may be a particularly labor-intensive process, requiring hours of effort and downtime. Paper cutting parts are also prone to wear, and typically require special storage. Again, if a single type of paper stock is used, such as described in the exemplary embodiments provided herein, the costs associated with using many specialized paper cutting tools, such as part cost, maintenance complexity, and part storage, are reduced. Ultimately, using a single type of paper, i.e., having both side notches and holes, may offer reduced paper costs and increased production efficiency.

The foregoing exemplary embodiments are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A paper dispensing apparatus for dispensing sheets of paper for a patty forming machine, wherein each sheet of paper has notches and a hole, the paper dispensing apparatus comprising:
a frame which connects the paper dispensing apparatus to the patty forming machine and is configured to dispense a sheet of paper from among the sheets of paper;
a hopper which is connected to the frame and configured to hold the sheets of paper in a stack within an inner space of the hopper, and the hopper includes a bottom opening from which the sheets of paper are dispensed;
a pair of guides within the hopper, wherein each guide of the pair of guides is disposed on an inner surface of a sidewall of the hopper, and the pair of guides are formed to correspond to a shape of the notches in the sheets of paper and the pair of guides are configured to hold the sheets of paper within the hopper; and
a rod which is mounted in the frame and extends upward through the inner space of the hopper, wherein the rod is configured to fit through the holes of the sheets of paper.

2. The paper dispensing apparatus of claim 1, wherein a sheet of paper is dispensed from the bottom opening in the hopper by application of a force which tears the sheet being dispensed such that the hole in the sheet being dispensed is torn from around the rod.

3. The paper dispensing apparatus of claim 1, wherein the frame and the hopper are integrally formed.

4. The paper dispensing apparatus of claim 1, wherein each of the guides includes a protruding portion which protrudes toward a respective notch in each of the sheets of paper within the hopper.

5. The paper dispensing apparatus of claim 4, wherein the protruding portion of each of the guides includes a tip which is closest to the respective notch in each of the sheets of paper, and a base portion which is connected to a respective sidewall of the hopper.

6. The paper dispensing apparatus of claim 5, wherein the tip and the base portion are integrally formed.

7. A sheet of wax-coated paper for separating patties of food produced by a food portioning machine having a paper feeding apparatus for dispensing a bottom-most sheet of paper from a vertical stack of a plurality of sheets of the wax-coated paper, each sheet of the wax-coated sheet of paper comprising:
a pair of notches formed respectively at left and right edges of the sheet of wax-coated paper, wherein each of the notches are configured to receive a male guide within the paper feeding system; and
a hole formed in the sheet of wax-coated paper, wherein the hole is configured to accommodate a retaining rod within the paper feeding apparatus,
wherein the hole is formed at a location near a rear edge of the sheet of wax-coated paper, and the hole is formed of a predetermined size so that the hole of the bottom-most sheet of wax-coated paper rips as the bottom-most sheet of wax-coated paper is torn from around the retaining rod during the dispensing of the bottom-most sheet of wax-coated paper.

8. The sheet of wax-coated paper according to claim 7, wherein the sheet of wax-coated paper is square in shape.

9. The sheet of wax-coated paper according to claim 7, wherein the notches are semi-circular in shape.

10. The sheet of wax-coated paper according to claim 7, wherein the hole is circular in shape.
